(19) United States
(12) Patent Application Publication
(10) Pub. No.: US 2006/0136986 A1
(43) Pub. Date: Jun. 22, 2006

(54) Enterprise security monitoring system and method

(76) Inventor: Robert W. Doolittle, San Diego, CA (US)

Correspondence Address: DALINA LAW GROUP, P.C., 7910 IVANHOE AVE. #325, LA JOLLA, CA, 92037, US

(21) Appl. No.: 11/015,340

(22) Filed: Dec. 17, 2004

(51) Int. Cl. H04L 9/00; G06F 12/14; G06F 17/00; G06F 11/00; H04K 1/00; G06F 11/22; G06F 11/30; G06F 11/32; G06F 11/34; G06F 11/36; G06F 12/16; G06F 15/18; G08B 23/00

(52) U.S. Cl. 726/1; 726/22

(57) ABSTRACT

Embodiments of the invention provide an enterprise security solution wherein each network node itself enforces a predetermined security policy. In these embodiments, platform independent agents and coordinators run on any type of network node and require no central server to implement policy are utilized. With no requirement for access to a server, the security policy of a network node may be enforced without an operable network connection. Agents are responsible for monitoring, recording and reporting attempted violations of predetermined security policies of an enterprise. Agents may be general agents and may be written in a platform independent language or may be special agents that may comprise platform specific code whether written in a platform independent language or not. Coordinators are responsible for configuring, controlling and providing support services such as routing to the agents. Agent and coordinator functionality may be combined into one component if desired. Agents and coordinators are capable of terminating processes on network nodes that they are monitoring. A policy may be specific to a device, user, group or enterprise or any combination thereof. Agents and coordinators may be deployed via disks, via the network via push technologies, or via download from the network. After agents and coordinators have been installed on a network node the security policy is enforced and may not be terminated without administrator privilege. Embodiments of the invention may be controlled and administered remotely without technical support at each network node site from any location hosting an administrator. This allows for flexible administration that is not dependent on the location of the administrator. In addition, since network connections may become inactive, it is possible for an administrator to change locations while administering a network node.

### BACKGROUND OF THE INVENTION

1. Field of the Invention

Embodiments of the invention described herein pertain to the field of computer security. More particularly, but not by way of limitation, these embodiments enable the monitoring and enforcement of security on network nodes.

2. Description of the Related Art

Existing enterprise security monitoring solutions operate by either monitoring traffic through standalone devices such as a router or through services running on a network node. Standalone devices by definition comprise a single point of failure for the security of an enterprise. Service based solutions comprise processes that are ported to a given platform and are dependent on the operating system of each network node. Service based solutions are expensive to develop and maintain since an enterprise may comprise many heterogeneous network nodes hosting a variety of operating systems and versions. In addition, service based solutions employ client server architectures that check security policies on a server and therefore comprise a single point of failure at the server. When the server is off line, security checking is affected. Furthermore, current security monitoring solutions require operable network connections in order to enforce policies.

Both standalone and service based solutions are inneffective policy enforcement solutions since the architecture upon which they are built is reactive and requires a single element to obtain a activity log and compute and implement the security policy of an enterprise which may be diverse in network nodes, geography and connection speed and availability.

These systems fail to satisfactorily implement a robust level of security required within an enterprise and are expensive and difficult to maintain. A need exists for a solution that is capable of autonomously running on any type of network node within an enterprise which is independent of a centralized security server and which does not require extra hardware.

### BRIEF SUMMARY OF THE INVENTION

Embodiments of the invention provide an enterprise security solution wherein each network node itself enforces a predetermined security policy. In these embodiments, platform independent agents and coordinators that execute on any type of network node and require no central server to implement policy are utilized. With no requirement for access to a server, the security policy of a network node may be enforced without an operable network connection. Example network node types include PCs, PDAs, cell phones, or any other electronic device capable of communicating data or storing data on element such as disks, memory sticks, compact flash cards or any other type of storage device.

Agents are responsible for monitoring, recording and reporting attempted violations of predetermined security policies of an enterprise. Agents may be general agents and may be written in a platform independent language or may be special agents that may comprise platform specific code whether written in a platform independent language or not. Coordinators are responsible for configuring, controlling and providing support services such as routing to the agents. Agent and coordinator functionality may be combined into one component if desired. Agents and coordinators are capable of terminating processes on network nodes that they are monitoring. A policy may be specific to a device, user, group or enterprise or any combination thereof. In addition, agents may comprise functionality to assess vulnerability as well and act upon and/or inform administrators as to the nature of the vulnerability. New vulnerabilities may be passed between agents and defined in XML files that declaratively describe vulnerabilities and optionally actions to be taken based on the particular vulnerability. Agents and coordinators may be deployed via disks, via the network via push technologies, or via download from the network. After agents and coordinators have been installed on a network node the security policy is enforced and may not be terminated without administrator privilege.

Embodiments of the invention may be controlled and administered remotely without technical support at each network node site from any location hosting an administrator. This allows for flexible administration that is not dependent on the location of the administrator. In addition, since network connections may become inactive, it is possible for an administrator to change locations while administering a network node.

Each agent monitors hardware, files, executables, ports and system configuration according to the employed policy. When an attempt to violate a policy is detected, an alert is sent to defined coordinators. The defined coordinators are supplied a network node identification along with a user identification and the attempted policy transgression. If the network node is currently coupled with the network the violation is immediately sent to at least one coordinator. If the network node is not currently coupled with the network, then the security policy is enforced and the attempted policy transgression is stored and sent to the defined coordinators when the network node is once again coupled with the network.

Embodiments of the invention may be implemented using TCP/IP and HTTP for communications and may also comprise more than one agent and a foundation component to control multiple agents per network node. A peer-to-peer architecture such as for example JXTA™ may be employed in embodiments of the invention in order to provide hierarchical or true peer-to-peer topologies.

### BRIEF DESCRIPTION OF THE DRAWINGS

FIG. 1 shows an architectural view of an embodiment of the invention.

FIG. 2 shows a flowchart of the initial startup of the invention.

FIG. 3 shows a flowchart of the handling of an event by an agent.

FIG. 4 shows a flowchart of the handling of an event by a coordinator.

FIG. 5 shows an embodiment of an XML event as sent from an agent to a coordinator.

### DETAILED DESCRIPTION OF THE INVENTION

Embodiments of the invention provide an enterprise security solution wherein each network node itself enforces a predetermined security policy. In these embodiments, platform independent agents and coordinators run on any type of network node and require no central server to implement policy are utilized. With no requirement for access to a server, the security policy of a network node may be enforced without an operable network connection.

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Any mathematical references made herein are approximations that can in some instances be varied to any degree that enables the invention to accomplish the function for which it is designed. In other instances, specific features, quantities, or measurements well-known to those of ordinary skill in the art have not been described in detail so as not to obscure the invention. Readers should note that although examples of the invention are set forth herein, the claims, and the full scope of any equivalents, are what define the metes and bounds of the invention.

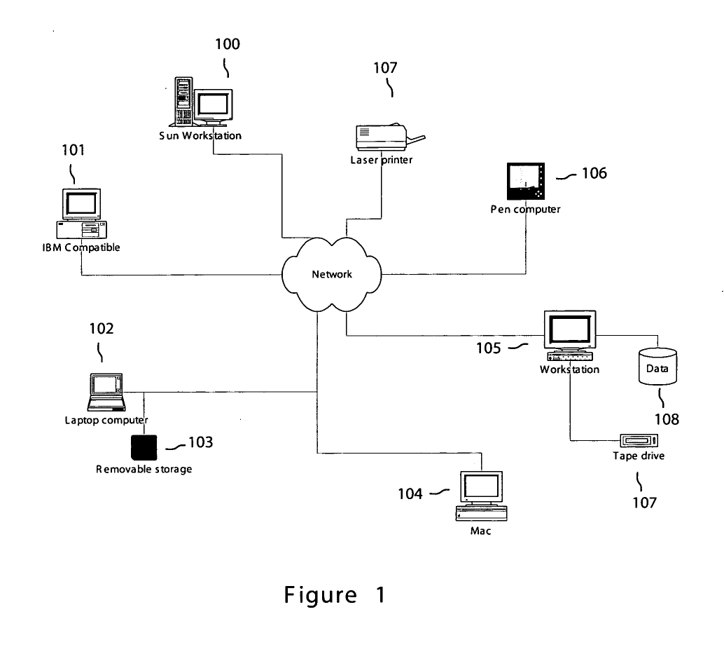

FIG. 1 shows an architectural view of an embodiment of the invention. The system may comprise multiple network nodes, each comprising a processor capable of hosting at least one coordinator and at least one agent. Network node 100 for example may comprise a Sun Workstation. Network nodes 100, 101, 102, 104, 105, 106 and 107 may comprise a heterogeneous array of device types and operating systems. Storage devices 103, 107 and 108 may also comprise a variety of storage types, formats and media. An administrator may for example reside on network node 106 in one embodiment a pen based computing solution. An administrator may control the operation of coordinators hosted on any network node from any other network node. If network node 102, in this embodiment a laptop, is removed from the network, an agent residing on the laptop will still monitor, log events that may or optionally may not violate the security policy of the network node and protect the laptop. Optionally a separate journal in addition to the log may be utilized to store events that are appropriate for administrators to review. For example when a user attempts to write information to a floppy disk storage device 103, the event is monitored by a disk event agent and logged to the local machine. When the laptop is reconnected to the network, then the logged event will be sent to an administrator hosted on any node in the network. Network node 107 in one embodiment a printer may also host an agent so that a user attempting to print a document when directly connecting to the printer for example is subject to the security policy of the printer. Virtually any type of device that an enterprise possesses may utilize the system and methods described herein.

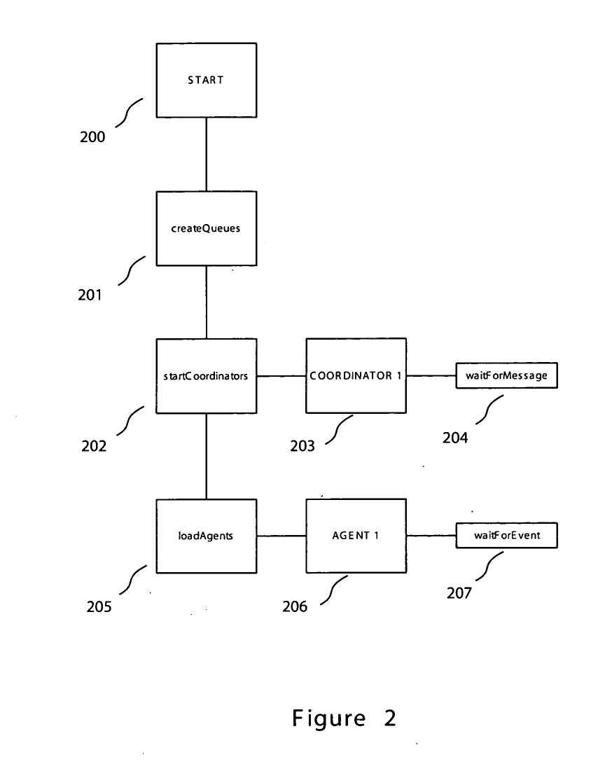

FIG. 2 shows a flowchart of the initial startup of the invention. Startup begins at 200 after which queues for the various coordinators are created and initialized at 201. The coordinators are started at 202. An example coordinator is created at 203 and may be implemented as a thread or standalone process. Each coordinator begins processing by waiting for messages at 204 from any associated agents. Agents remain small in this manner since they are devoted to their specific task while each coordinator is responsible for dealing with the events that their associated agents generate. Each agent specified in the configuration for a given embodiment of the invention is loaded at 205. An example agent is created at 206 and may be implemented as a thread or standalone process. Each agent determines the status of any associated element that it is specifically watching and waits for an event from the associated element at 207.

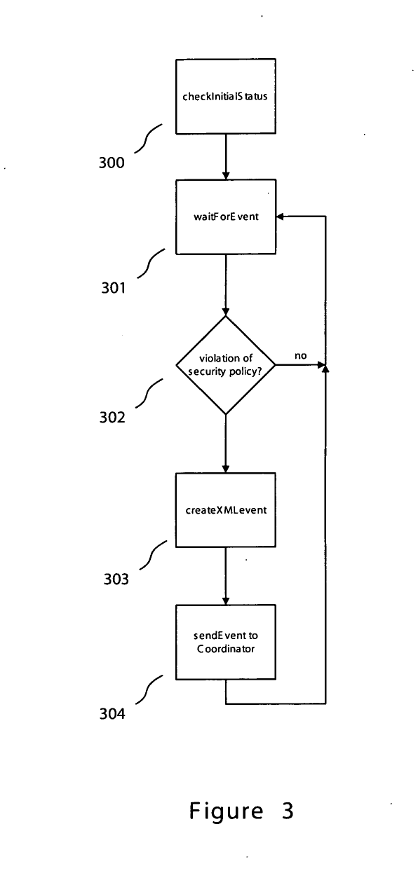

FIG. 3 shows a flowchart of the handling of an event by an agent. The initial status of the element, for example a storage device such as a disk or memory stick, is saved upon entry into the agent at 300. The agent then waits for, either via polling or via interrupt, for an event from the element at 301. When an event is detected, it is checked with the security policy for the machine at 302. If the security policy has not been violated then the agent returns to waiting for events at 301. If the security policy has been violated, then the agent creates an XML event at 303 and sends the event to the associated coordinator at 304. Optionally, all events may be sent to an associated coordinator as either marked in the event or at the coordinator as to a non-violation. This may for example be done in order to log all activity on a machine to generate security histograms or for any other function. Once the event has been sent at 304, the agent returns to wait for more events at 301.

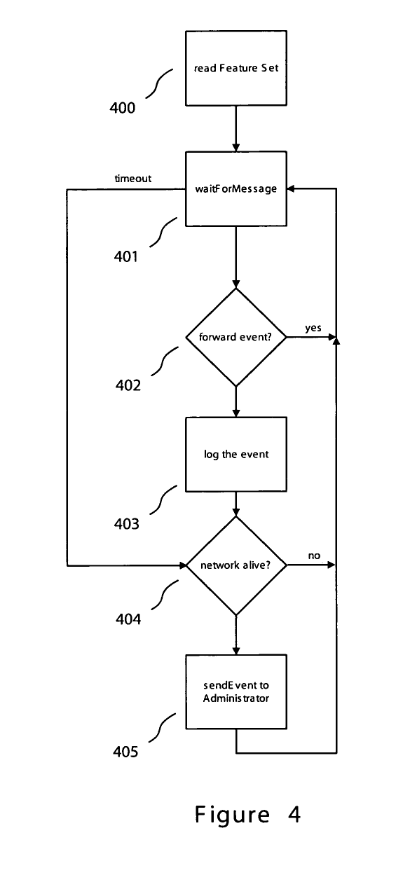

FIG. 4 shows a flowchart of the handling of an event by a coordinator. The feature set of the configuration is read at 400 and used in order to determine what capabilities are to be utilized on the network node. The feature set determines the collection of agents authorized for use on a network node. The feature set may be implemented as an XML file, as an encrypted binary file, may be hardwired, and may involve requesting the information from a coordinator. The coordinator then waits for messages to come in from either other coordinators or from agents at 401. For example, when an agent detects an event that is to be sent to a coordinator, the message is sent to the queue of the coordinator which wakes up the coordinator at 401. If the event is an event that is to be forwarded to and handled by another coordinator at 402, then the coordinator simply forwards the event and proceeds to waiting again at 401. If the event is not to be forwarded, then it is logged locally at 403 and if the network is operational, then the event is sent to an administrator at 405. If the network is not operational then the coordinator returns to waiting for more events at 401. If there has been no event for a predetermined amount of time, then the wait at 401 times out and if the network is alive then any logged events that have yet to be sent are sent to an administrator at 405. Optionally a separate thread may detect that the network is operational and send an event or message that is received at 401. In this alternate methodology, no timeout branch links 401 with 404 since in effect this embodiment is a purely event driven method. The events may be sent over HTTP using XML for example in order to operate through most corporate firewalls. Any other network communications protocol may be used so long as events may be sent between network nodes. The functionality of agents and coordinators may be combined into one component, but for ease of maintenance and simplified object oriented design at least one embodiment of the invention separates this functionality.

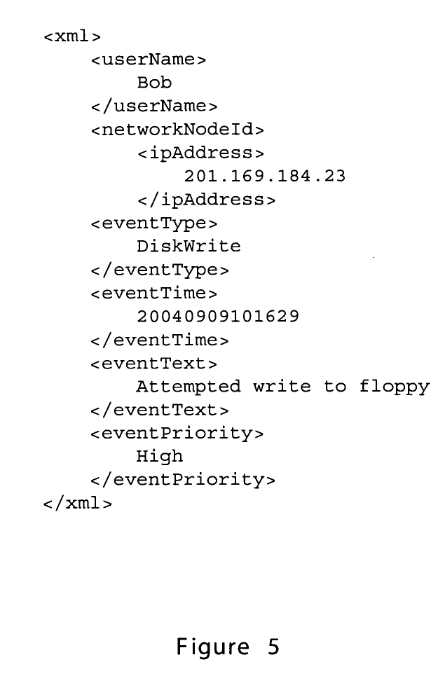

FIG. 5 shows an embodiment of an XML event as sent from an agent to a coordinator. The event comprises a username, IP address, event type, event time, event text, and event priority. The event is logged and may be forwarded from the coordinator to an administrator when a network connection is available. Any encoding of data may be sent between the agent and an associated coordinator, however XML provides a human readable format that is easy to understand. Any other encoding format may be used in embodiments of the invention and any event message sent to an administrator may be encrypted and digitally signed for example to ensure that it is valid.

Thus embodiments of the invention directed to an Enterprise Security Monitoring System and Method have been exemplified to one of ordinary skill in the art. The claims, however, and the full scope of any equivalents are what define the metes and bounds of the invention.

What is claimed is:

1. An enterprise security monitoring system comprising:
a network node;
a security policy collocated with said network node; and,
an agent coupled with said network node wherein said agent is configured to monitor an event on said network node using said security policy without accessing a server hosted security policy and without requiring an operational network connection wherein said agent is configured to log said event and forward said event to alert an administrator when said network connection becomes operational.

2. The system of claim 1 further comprising at least one coordinator configured to perform network communication and coordination and wherein said agent does not comprise functionality capable of network communication and coordination.

3. The system of claim 1 further comprising a network.

4. The system of claim 1 further comprising a laptop computer.

5. The system of claim 1 further comprising a pen based computer.

6. The system of claim 1 further comprising a printer.

7. The system of claim 1 further comprising a storage device capable of writing to a removable media.

8. The system of claim 7 wherein said storage device is a floppy disk.

9. The system of claim 7 wherein said storage device is a CD writer.

10. The system of claim 7 wherein said storage device is a DVD writer.

11. The system of claim 7 wherein said storage device is a memory stick.

12. The system of claim 7 wherein said storage device is a removable hard disk.

13. An method for using an enterprise security monitoring system comprising:
installing an agent on a network node;
monitoring an event on said network node based on a security policy collocated with said network node without accessing a server hosted security policy and irrespective of network connection status;
logging an event based on said security policy;
forwarding said event to an administrator when said network connection becomes operational; and,
alerting said administrator to said event.

14. The method of claim 13 further comprising:
configuring a feature set of said agent by said administrator.

15. The method of claim 13 further comprising:
configuring a security policy for use via said agent by said administrator.

16. The method of claim 13 further comprising:
relocating an administrator to a second network node wherein said administrator may continue to monitor and control said network node.

17. An enterprise security monitoring system comprising:
means for installing an agent on a network node;
means for monitoring an event on said network node based on a security policy collocated with said network node without means for accessing a server hosted security policy irrespective of network status;
means for logging an event based on said security policy;
means for forwarding said event to an administrator when said network connection becomes operational; and,
means for alerting said administrator to said event.

18. The system of claim 17 further comprising:
means for configuring a feature set of said agent by said administrator.

19. The system of claim 17 further comprising:
means for configuring a security policy for use via said agent by said administrator.

20. The system of claim 17 further comprising:
means for relocating an administrator to a second network node wherein said administrator may continue to monitor and control said network node. Express Mail # ED 266025621 US 16
